(19) United States
(12) Patent Application Publication
(10) Pub. No.: US 2025/0368345 A1
(43) Pub. Date: Dec. 4, 2025

(54) Unducted Thrust Producing System

(71) Applicant: General Electric Company, Evendale, OH (US)

(72) Inventors: Keith Edward James Blodgett, Milford, OH (US); Alexa Roberts, Cincinnati, OH (US); William Joseph Bowden, Cleves, OH (US)

(21) Appl. No.: 19/224,187

(22) Filed: May 30, 2025

Related U.S. Application Data
(60) Provisional application No. 63/653,538, filed on May 30, 2024.

(51) Int. Cl. B64D 33/04; B64D 27/12

(52) U.S. Cl. CPC B64D 33/04; B64D 27/12

(57) ABSTRACT

A thrust producing system for an aircraft includes a turbomachine; a fan rotatably driven by the turbomachine; and a downward and/or laterally outward canted outlet nozzle. The outlet nozzle includes a core nozzle with a core nozzle segment with a decreasing cross-sectional area in an axial direction toward an exhaust end of the outlet nozzle; and an aft core cowl, positioned radially outward with respect to and surrounding the core nozzle segment. The aft core cowl comprises an aft core cowl segment with a decreasing cross-sectional area in the axial direction. Surfaces of the core nozzle segment and the aft core cowl segment transition together into surfaces that are parallel with respect to each other along the axial direction, such that during operation of the thrust producing system, a bypass or third exhaust stream scrubbing the aft core cowl entrains a core exhaust stream expelled through the core nozzle.

### PRIORITY INFORMATION

This patent application claims benefit of priority to U.S. Provisional Application No. 63/653,538, entitled “UNDUCTED THRUST PRODUCING SYSTEM” and filed on May 30, 2024, which is hereby incorporated herein by reference in its entirety.

### TECHNICAL FIELD

These teachings relate generally to an aircraft with a fan propulsor, and, more particularly, to an outlet nozzle for a fan propulsor.

### BACKGROUND

Aircraft generally include a propulsion system that generates thrust. The propulsion system may include at least two engines, such as turbofan or turboprop jet engines mounted on each wing of the aircraft. A turboprop jet engine generates thrust by compressing incoming air using a fan and igniting the compressed air to create a high energy exhaust gas. The high energy exhaust gas passes through one or more turbines that drive the fan and further exits through a rear nozzle to generate thrust.

### BRIEF DESCRIPTION OF DRAWINGS

Various needs are at least partially met through provision of the unducted thrust producing system and methods described in the following detailed description, particularly when studied in conjunction with the drawings. A full and enabling disclosure of the aspects of the present description, including the best mode thereof, directed to one of ordinary skill in the art, is set forth in the specification, which refers to the appended figures, in which:

FIG. 1 is a perspective diagram of a portion of an aircraft;

FIG. 2 is a cross-sectional view of an exemplary aircraft engine;

FIG. 3 is a first schematic diagram of the interaction of a core exhaust stream and a bypass stream;

FIG. 4 is a second schematic diagram of the interaction of a core exhaust stream and a bypass stream;

FIG. 5 is a third schematic diagram of the interaction of a core exhaust stream and a bypass stream;

FIG. 6 is a perspective diagram of an exemplary outlet nozzle of an aircraft engine;

FIG. 7 is a cross-sectional perspective diagram of the exemplary outlet nozzle;

FIG. 8 is a cross-sectional side view diagram of the exemplary outlet nozzle;

FIG. 9 is a cross-sectional diagram of a connection between an aft core cowl and a core nozzle;

FIG. 10 is a rear view of a first exemplary outlet nozzle;

FIG. 11 is a rear view of a second exemplary outlet nozzle; and

FIG. 12 is a flowchart for an exemplary process performed by an outlet nozzle.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. For example, while a series of blocks are described with respect to particular figures, the order of the blocks may be modified in other implementations. Further, non-dependent blocks may be performed in parallel.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated. The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise. Further, the phrase “based on” is intended to mean “based, at least in part, on” unless explicitly stated otherwise. No element, act, or instruction in the present application should be construed as critical or essential to the embodiments described herein unless explicitly described as such.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 5, or 10 percent margin. These approximating margins may apply to a single value, either or both endpoints defining numerical ranges, and/or the margin for ranges between endpoints. Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

It is additionally noted that the term “substantially” is also utilized herein to represent an inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary. As used herein, the terms “first”, “second”, and “third” may be used interchangeably to distinguish one component from another and are not intended to signify location or importance of the individual components.

The terms “forward” and “aft” refer to relative positions within a gas turbine engine or vehicle and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows. The term “mean direction of flow,” with respect to an exhaust stream, refers to a mean average of all flow from a particular exhaust, taking into account both magnitude and direction of all of such flow. The mean direction of flow may refer to the mean direction of flow during a steady state operation, such as during cruise operations.

A “third stream” as used herein means a non-primary air stream capable of increasing fluid energy to produce a minority of total propulsion system thrust. A ducted turbofan may generate two main exhaust streams: a core exhaust stream and a bypass stream. An unducted thrust producing system may generate three exhaust stream: a core exhaust stream, a bypass flow stream corresponding to an unducted fan stream generated by the unducted fan on the outside of the engine, and a third stream generated through a guided bypass flowpath disposed radially outward from the turbomachine flowpath of the core exhaust stream. A pressure ratio of the third stream may be higher than that of the primary propulsion stream (e.g., a fan or propeller driven propulsion stream). The thrust may be produced through a dedicated nozzle or through mixing of an airflow through the third stream with a primary propulsion stream or a core air stream, e.g., into a common nozzle.

In certain exemplary embodiments, an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments, these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, static flight speed, 86 degree Fahrenheit ambient temperature operating conditions.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

An unducted thrust producing system for an aircraft may be associated with various design challenges. For an underwing open fan engine installation, higher efficiency and optimal locations for installation may require placing the engine relatively vertically close to the wing. Thus, the engine is close-coupled with the wing and/or the engine may be pitched down relative to the aircraft to improve performance and noise. The closer the engine installation is to the wing, the higher the risk of hot core exhaust gas impinging on deployed wing flaps. Wing flaps will be deployed during some aircraft operating conditions, such as during takeoff, approach, landing, etc. The location of the engine may result in jet-flap interactions, such as, for example, unsteady loads and/or high temperatures experienced by the trailing edge flap system of the aircraft. To mitigate this risk, the engine core exhaust could be re-directed, such as with a canted, internal plug core nozzle.

Thus, a solution is to design a fixed, but canted, core nozzle to direct the energetic and hot core stream away from the wing and flaps. However, there is a performance penalty for this canting at all flight conditions because the core's thrust vector is not aligned with the rest of the engine's thrust. Therefore, enacting a canted, internal plug nozzle yields some efficiency penalties which should be addressed. These penalties include thrust efficiency, the nozzle's ability to effectively expand high pressure exhaust flow into thrust, and/or flow efficiency, the nozzle's ability to pass the turbomachinery exhaust gas flow through as physically small a nozzle as possible. Smaller nozzles have lower drag and weight.

Implementations described herein relate to an unducted thrust producing system and a method of using the same. Features of the unducted thrust producing system include the combination of an internal plug core nozzle, historically for acoustics or infrared (IR) signature motivations, and a canted core nozzle, historically for avoiding exhaust-flap impingement. The motivation for the open fan canted core nozzle is exhaust-flap impingement avoidance. There are specific and unique embodiments to make this nozzle efficient, including a core nozzle flow that is annularly interior of a jet exhaust stream that may be of higher pressure and lower temperature (third stream or bypass stream), and a core nozzle's closeout that is cylindrical in shape such that core exhaust flow exits its nozzle parallel to exhaust jet surrounding it.

To maximize a core nozzle's efficiencies, a design feature is identified. This feature is ensuring the core exhaust flow and surrounding bypass or third stream nozzle flow, are parallel or close to parallel, at the core nozzle exit. While a parallel flow between the core exhaust flow and the surrounding bypass or third stream flow may be most efficient, if the core exhaust flow and the bypass or third exhaust flow are off parallel but less than a threshold angle, the off-parallel flow may still provide advantages. During operation of the unducted thrust producing system of the engine, an exhaust stream and a bypass or third stream may be generated by the engine and fan. The core nozzle may be canted downward and/or laterally outward (e.g., away from the fuselage) with respect to a centerline axis of the engine. The core nozzle may expel a core exhaust stream and the aft core cowl may be scrubbed by a bypass or third stream. The core nozzle may include a core nozzle segment that has an interior surface having a decreasing surface curvature in an axial direction and decreasing cross-sectional area toward the exhaust end of the nozzle. The aft core cowl, positioned radially outward with respect to and surrounding the core nozzle segment, may include an aft core cowl segment that has an exterior surface having a decreasing surface curvature in the axial direction and decreasing cross-sectional area toward the exhaust end of the nozzle. The decreasing surface curvature of the interior surface of the core nozzle segment and the decreasing surface curvature of the exterior surface of the aft core cowl segment may both transition together into surfaces that are parallel with respect to each other along the axial direction toward the exhaust end of the outlet nozzle, such that during operation of the unducted thrust producing system, a bypass or third exhaust stream scrubbing the aft core cowl entrains a core exhaust stream expelled through the core nozzle. Entrainment of the core exhaust stream by the bypass or third exhaust stream improves the efficiency of the thrust generated by the unducted thrust producing system of the engine.

Additionally, the shape of the exhaust end of the outlet nozzle may cause inefficiencies. For example, two outlet nozzles may be present on an aircraft, each centered at approximately the same location relative to the wing. A circular nozzle may exhibit risk of impingement, because it may overlap the wing flaps. If a circular nozzle is chosen, either the wing flaps may need redesigning, with an efficiency penalty, or the engine may need to be dropped further below wing, extending landing gear. These two scenarios may be undesirable for aircraft lift and/or weight reasons, respectively.

Implementations described herein further include an elliptical outlet nozzle. An elliptical nozzle, as viewed upstream into nozzle, from nozzle exit, may avoid flap impingement. The internal plug core nozzle's exit may be shaped as an ellipse, defined by semi-major axes lengths a and b, where a is oriented approximately parallel to a ground plane or a wingspan of the aircraft, and where b is vertical and normal to a. As a increases relative to b, the ellipse becomes flatter. When a and b are equal, the nozzle exit is perfectly circular. As the nozzle flattens with a>b, the 12 o'clock flow portion of nozzle flow is relatively further away from wing and flaps, further reducing the risk of hot gas impingement. Additionally, an elliptical nozzle may provide installation advantages, as there is less risk of interference from the wing flaps or other parts of the wing during installation of the engine and/or the outlet nozzle.

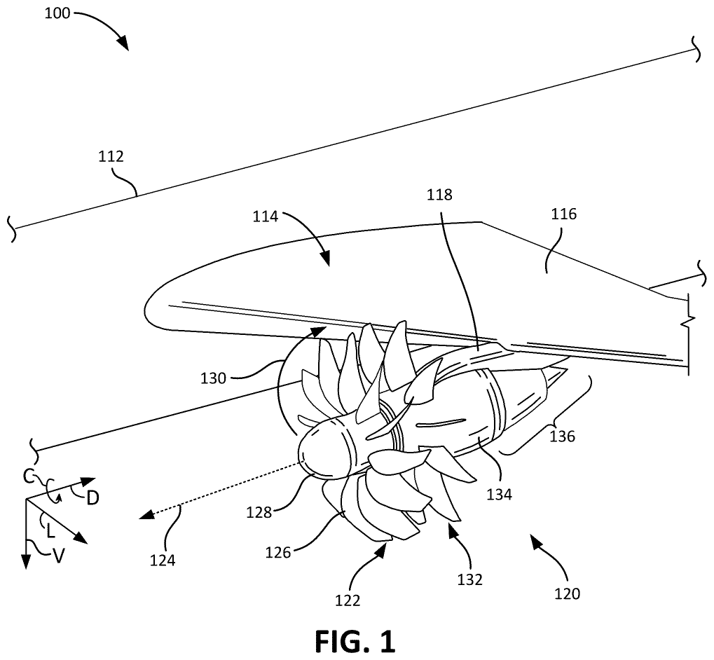

Referring now to the drawings, wherein identical numerals indicate the same elements throughout the figures, FIG. 1 is a perspective view of a portion of an aircraft 100. The aircraft 100 includes a fuselage 112, a wing 114 (with an upper surface 116), a pylon 118, and an engine 120. The aircraft 100 defines a vertical direction V, a downstream direction D, a lateral direction L, and a circumferential direction C. In this example, the downstream direction D is a direction of airflow from a front or forward end (e.g., to the left and out of the page in FIG. 1) of aircraft 100 to a rear or aft end (e.g., to the right and into the page in FIG. 1) of aircraft 100.

The fuselage 112 is a main body or vessel section of aircraft 100 that contains cargo, passengers, a crew, or a combination thereof during normal operation. The wing 114 is an aerodynamic portion of aircraft 100 mounted to and extending from fuselage 112 that provides lift for the aircraft 100. The upper surface 116 is a surface extending along a topside of wing 114 relative to vertical direction V (shown as pointing downwards in FIG. 1). As will be appreciated, the wing 114 may define an airfoil shape, and the upper surface 116 may be the suction side of the airfoil. Such a configuration may cause an upwash of the airflow approaching the wing 114 during flight, as will be described further below.

The engine 120 of the aircraft 100 may include a fan 122 having a plurality of fan blades 126, a spinner or nose 128, a plurality of stationary outlet guide vanes 132, a casing 134, and an exhaust section 136. Further, the engine 120 defines a centerline axis 124, and the fan 122 defines a direction of rotation 130 about the centerline axis 124. The engine 120 may be mounted to the wing 114 by the pylon 118, which connects the engine 120 to the wing 114. The engine 120 is a machine or thrust producing system for providing thrust for the aircraft 100. In this example, the engine 120 may be configured as an unducted single fan (e.g., fan 122). More specifically, in the embodiment shown, the engine 120 may include a single row of unducted rotor blades (e.g., fan blades 126, as described below).

The fan 122 may include a rotatable propeller configured to rotate about the centerline axis 124. The fan 122 may be mounted at an upstream end of the engine 120 and is configured to rotate relative to the casing 134. Thus, the fan 122 may be rotatably driven by the engine 120. The fan 122 may include the fan blades 126, which are airfoil vanes configured to rotate with the fan 122 about the centerline axis 124. In this example, the fan blades 126 define a stage of unducted rotor blades. The fan blades 126 are connected to and extend outward along a radial direction from the nose 128 of the fan 122.

Moreover, in some implementations, the engine 120 may include the outlet guide vanes 132. The outlet guide vanes 132 are non-rotating airfoils or stator vanes that guide or redirect a direction of airflow. The outlet guide vanes 132 define a stage of outlet guide vanes that are located downstream of the fan blades 126 (e.g., the stage of unducted rotor blades). In one example, the outlet guide vanes 132 may be fixed stator vanes. In another example, the outlet guide vanes 132 may be adjustable or variable pitch guide vanes. The outlet guide vanes 132 may be mounted to a portion of the casing 134. The casing 134 is a housing or exterior wall of the engine 120 that forms an external barrier or wall of engine 120.

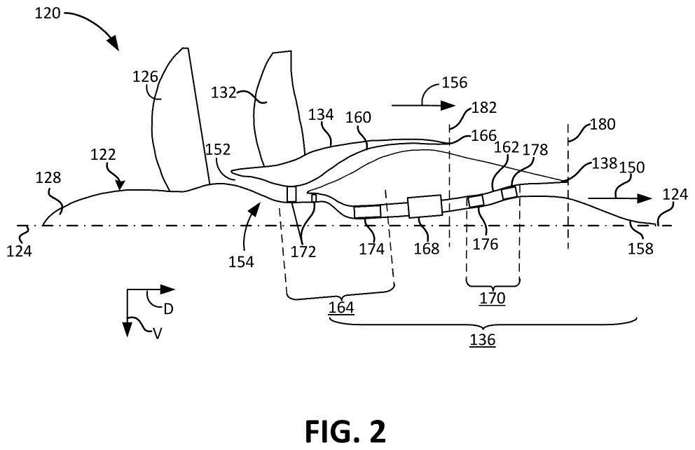

Referring now to FIG. 2, a cross-sectional view of the engine 120 is shown. The engine 120 may include an inlet 152, a turbomachine 154 defining the centerline axis 124, the fan 122 connected to and disposed upstream from the turbomachine 154, and the exhaust section 136 including an outlet nozzle 138, the plug 158, and a bypass outlet nozzle 166. The engine 120 may define a fan stream 156 extending from the fan blades 126 and over the turbomachine 154. In FIG. 2 the fan stream 156 is depicted by an arrowhead disposed downstream from the fan 122. The outlet nozzle 138, also referred to herein as an “exhaust nozzle,” may provide an outlet nozzle exit for the exhaust flowpath 150. The plug 158 may facilitate directing the exhaust gases into the exhaust flowpath 150. As exhaust gases flow through the outlet nozzle 138, the exhaust gases flow between the outer surface of the plug 158 and the inner surfaces of the outlet nozzle 138. The exhaust flowpath 150 provides thrust to the aircraft 100 in the direction opposite the direction of the flow of the exhaust flowpath 150.

The turbomachine 154 may be coupled to the fan 122 via a shaft assembly (not shown in FIG. 2 for clarity) such that the turbomachine 154 is configured to drive rotation of the fan 122. The turbomachine 154 may receive air through the inlet 152 and produce rotational energy for the fan 122 and thrust by compressing the air, igniting a mix of the air and fuel to produce a high-pressure flow of combustion gases, and expanding the combustion gases.

The turbomachine 154 may define a bypass flowpath 160 and a working gas flowpath 162. The bypass flowpath 160 may extend through a portion of the turbomachine 154 that is disposed outward along a radial direction from the working gas flowpath 162. A bypass outlet nozzle 166 may provide a bypass outlet nozzle exit for the bypass flowpath 160. In this example, the bypass flowpath 160 may be a third stream flowpath (as described above). The bypass flowpath 160 may divert a flow of air away from the turbomachine 154 and deliver the air out of the bypass outlet nozzle 166 to provide additional thrust for the aircraft 100.

More specifically, in some implementations, the bypass flowpath 160 may extend from the working gas flowpath 162 to the fan stream 156. More specifically, the bypass flowpath 160 may extend from a low-pressure compressor of a compressor section 164, at a location downstream from a low-pressure compressor (LPC) blade 172 (e.g., a first stage of rotor blades of the low-pressure compressor, etc.), to the fan stream 156. In such a manner, the bypass flowpath 160 may receive compressed air from the working gas flowpath 162 and the airflow from the bypass flowpath 160 through the bypass outlet nozzle 166 may contribute to an overall thrust production of the engine 120.

Air from the inlet 152 may be provided to the working gas flowpath 162 and through the turbomachine 154. More specifically, the turbomachine 154 may include the compressor section 164, the combustion section (including, e.g., a combustor 168), and a turbine section 170 in serial flow order. The compressor section 164, the combustor 168, and the turbine section 170 together define at least in part the working gas flowpath 162. In some implementations, the compressor section 164 may include a low-pressure compressor with LPC blades 172) and a high-pressure compressor (HPC) with HPC blades 174. The turbine section 170 may include a high-pressure turbine (HPT) with HPT blades 176 and a low-pressure turbine (LPT) with LPT blades 178. Air from the inlet 152 may be progressively compressed through the low-pressure and high-pressure compressors across the LPC blades 172 and across the HPC blades 174, respectively. The compressed air may then be mixed with fuel and burned in the combustor 168 to generate combustion gases. The combustion gases may then be expanded through the high-pressure and low-pressure turbines across the HPT blades 176 and across the LPT blades 178, respectively extracting work. In some implementations, the high-pressure turbine may be coupled to the high-pressure compressor through a shaft or spool (not shown in FIG. 2) such that rotation of the high-pressure turbine drives the high-pressure compressor. Similarly, in some implementations, the low-pressure turbine may be coupled to the low-pressure compressor through a shaft or spool (not shown in FIG. 2) such that rotation of the low-pressure turbine drives the low-pressure compressor. The low-pressure turbine may further be configured to drive the fan 122.

The outlet nozzle 138 defines a nozzle outlet plane 180. The nozzle outlet plane 180 is a plane extending along a face of the outlet nozzle 138. For example, with the outlet nozzle 138 including an annular shape, an orientation of the nozzle outlet plane 180 may be defined by a plane along which an outer circumference of the outlet nozzle 138 lies. The nozzle outlet plane 180 may extend along the face of the outlet nozzle 138. A bypass outlet nozzle plane 182 defines an exit plane of the bypass outlet nozzle 166 and the nozzle outlet plane 180 defines an exit plane of the outlet nozzle 138. In some embodiments, thrust may be produced by the fan blades 126, by the bypass outlet nozzle 166, and by the outlet nozzle 138. For example, the engine 120 may be configured to propel the aircraft 100 and operate at a speed of greater than Mach 0.74 (570 miles per hour) and less than Mach 0.90 (729 miles per hour). In another example, the engine 120 can be configured to propel aircraft 100 (and operate) at a speed of Mach 0.79 (610 miles per hour).

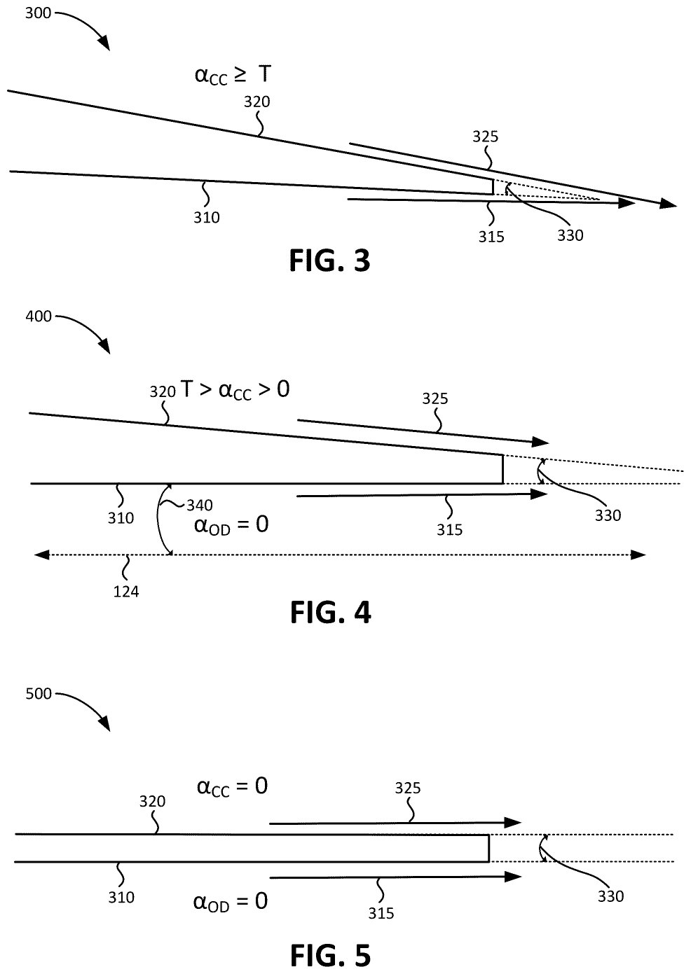

The interaction between a core exhaust stream and a bypass or third exhaust stream may lead to inefficiencies. FIGS. 3-5 illustrate interactions between a core exhaust stream and a bypass or third stream. FIG. 3 is a first schematic diagram 300 of the interaction of a core exhaust stream and a bypass stream or a third stream. As shown in FIG. 3, a core nozzle surface 310 may define a surface that shapes a core exhaust stream 315 and a core cowl surface 320 may define a surface that is scrubbed by a bypass or third exhaust stream 325. A stream “scrubbing” a surface, as the term is used herein, refers to the gas stream contacting the surface and following the direction of the surface due to the pressure differential created by the shape of the surface. Thus, the surface may entrain the gas stream and cause the gas stream to follow the curvature of the surface. The entrainment of the gas stream by the shape of the surface is referred to as the Coanda effect. The angle between the core exhaust stream 315 and the bypass or third exhaust stream 325 may be determined by a core cowl angle α_{CC} 330. The core cowl angle α_{CC} 330 corresponds to the angle between the surface of the core nozzle and the surface of the core cowl at the exhaust end of the nozzle. Thus, if a first line tangent to the surface of the core nozzle surface 310 were to be extended past the exhaust end of the nozzle, and if a second line tangent to the surface of the core cowl surface 320 were to be extended past the exhaust end of the nozzle, the angle between the first line and the second line would define the core cowl angle α_{CC} 330.

At large values of the core cowl angle α_{CC} 330, such as, for example, values above about 10 degrees, the bypass or third exhaust stream 325 may suppress the core exhaust stream 315 by directly impinging the core exhaust stream 315. The impingement by the bypass or third exhaust stream 325 may disrupt the core exhaust stream 315 and make a core exhaust nozzle less efficient at expanding the flow of the core exhaust stream 315 into thrust. This inefficiency may be expressed as a decrease in the velocity coefficient CV corresponding to a ratio of the actual velocity of the aircraft 100 and an ideal velocity of the aircraft 110 based on a theoretical velocity with no losses. Furthermore, the impingement by the bypass or third exhaust stream 325 may make a core exhaust nozzle less efficient at passing air flow through a given area, resulting in reduced thrust. This inefficiency may be expressed as a decrease in the flow coefficient CF corresponding to a ratio of the actual mass flow rate through the nozzle and an ideal mass flow rate through the nozzle based on a theoretical mass flow rate with no losses. As the value of the core cowl angle α_{CC} 330 decreases, the effect of the impingement effect goes down and transitions into an entrainment effect. At a threshold value of T for the core cowl angle α_{CC} 330, the impingement by the bypass or third exhaust stream 325 on the core exhaust stream 315 may drop below a threshold amount of impingement and/or the entrainment by the bypass or third exhaust stream 325 on the core exhaust stream 315 may rise above a threshold amount of entrainment. The amount of impingement or entrainment may be measured based on, for example, a change in the Mach number of the core exhaust stream 315 in response to encountering the bypass or third exhaust stream 325. The threshold amount of impingement may be selected as the amount of impingement that does not reduce the Mach number of the core exhaust stream 315 when the core exhaust stream 315 meets the bypass or third exhaust stream 325 at the exhaust end of nozzle.

FIG. 4 is a second schematic diagram 400 of the interaction of the core exhaust stream 315 and the bypass or third stream 325. As shown in FIG. 4, the core cowl angle α_{CC} 330 may be below the threshold value T and above a value of 0. FIG. 4 further shows a core nozzle outer diameter angle α_{OD} 340. Core nozzle outer diameter angle α_{OD} 340 corresponds to an angle between the centerline axis 124 of the engine 120 and the outer diameter of the outlet nozzle 138. Thus, the core exhaust stream 315 may be aligned with the centerline axis 124. Below the threshold value T of the core cowl angle α_{CC} 330, the bypass or third exhaust stream 325 may no longer suppress and/or impinge the core exhaust stream 315. Rather, at values below the threshold value T of the core cowl angle α_{CC} 330, the bypass or third exhaust stream 325 may entrain or educt the core exhaust stream 315. FIG. 5 is a third schematic diagram 500 of the interaction of the core exhaust stream 315 and the bypass or third exhaust stream 325. As shown in FIG. 5, the core cowl angle α_{CC} 330 may have a value of 0.

An outer flow, such as the bypass or third exhaust stream 325, may have a higher Mach number (e.g., a higher speed, etc.) than an interior core flow, such as the core exhaust stream 315. A gas stream with a higher Mach number has a lower static pressure. If an outer stream has a lower static pressure than a core stream, the outer stream may entrain or educt the higher-pressure stream along with it. This phenomenon may be referred to as a fluidic nozzle, or as an eductor or ejector effect. When a first fluid entrains or educts a second fluid, the first fluid draws in the second fluid and the second fluid mixes with the first fluid, resulting in the first fluid and the second fluid to flow in the same direction. Occasionally, in operation of two nozzles, one with an outer stream and one with an inner stream, the relative pressures may be reversed for the two nozzles.

The eductor effect may be most efficient when the flow of the outer stream and the inner stream are parallel, meaning that the core cowl angle α_{CC} 330 has a value of zero or, e.g., +/−2 degrees. If the outer stream and the inner stream are slightly off parallel (e.g., when the core cowl angle α_{CC} 330 is above zero, but below the threshold T), the eductor effect may exist but be less efficient. The eductor effect enables a more efficient exhaust nozzle by providing a higher flow efficiency, enabling an exhaust nozzle to be physically smaller and have a smaller exit area when designed to implement the eductor effect. Furthermore, the eductor effect enables a higher thrust efficiency, because the exhaust nozzle is able to expand pressurized air through the nozzle more efficiently to create thrust, when designed to implement the eductor effect. The eductor/ejector effect may be maximized for an internal plug nozzle arrangement. However, the eductor/ejector effect may also be implemented on an external plug nozzle, though with less effect, as the exhaust gas flow may still be contracting radially as the gas travels down the plug.

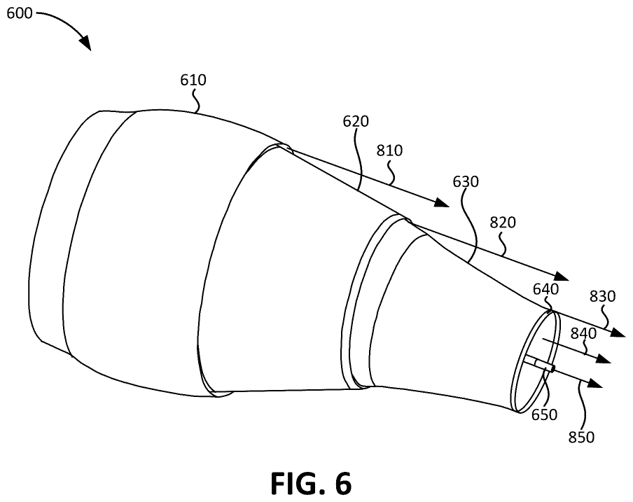

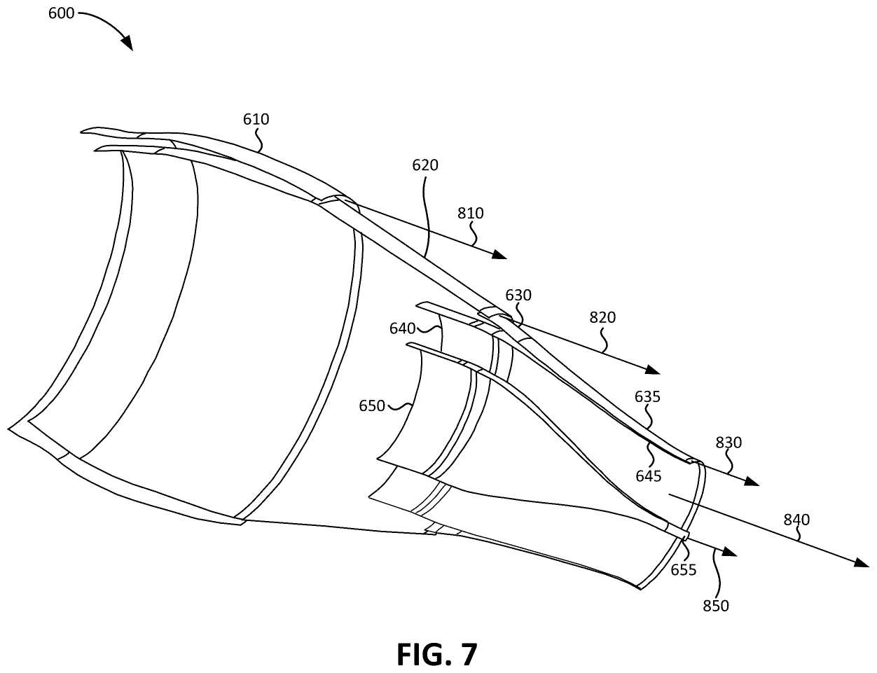

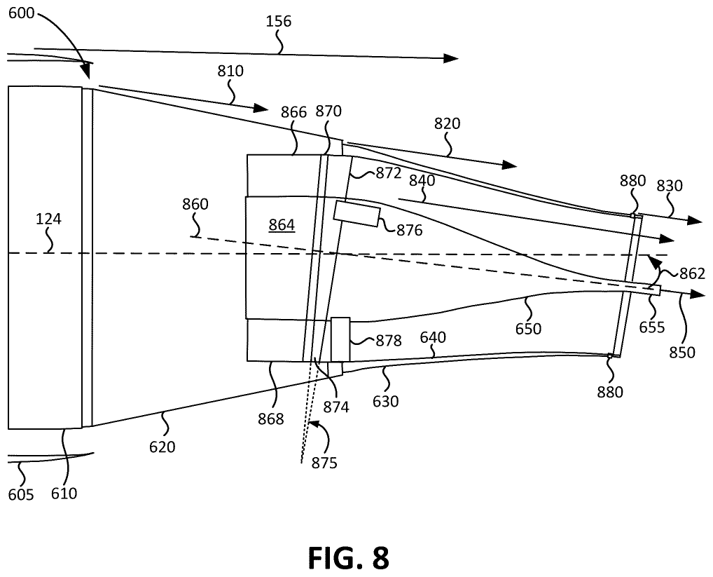

FIG. 6 is a perspective diagram of an exemplary outlet nozzle 600 that implements the eductor effect between a core exhaust stream and a bypass stream. FIG. 7 is a cross-sectional perspective diagram of the outlet nozzle 600. FIG. 8 is a cross-sectional side view diagram of the exemplary outlet nozzle 600. The outlet nozzle 138 and/or the bypass outlet nozzle 166 may be implemented as and/or include the outlet nozzle 600. During operation of the turbomachine 154 and the fan 122, an exhaust stream and a third stream are expelled from the outlet nozzle 600. The exhaust stream and the third stream provide thrust for the aircraft 100. Thus, the turbomachine 154, the fan 122, and the outlet nozzle 600 may together comprise an unducted thrust producing system of the aircraft 100.

As shown in FIG. 6, the outlet nozzle 600 may include a third stream nozzle 610, a core nozzle cowl that includes a forward core cowl 620 and an aft core cowl 630, a core nozzle 640, and a core plug 650. As shown in FIG. 8, the outlet nozzle 600 may be surrounded by an external nacelle 605. The external nacelle 605 may correspond to a radially outward nacelle that is forward of the outlet nozzle 600 and centered along the centerline axis 24. The external nacelle 605 may be scrubbed by the fan stream 156. The external nacelle 605 is not shown in FIGS. 6 and 7 for clarity purposes.

In some implementations, the third stream nozzle 610, the forward core cowl 620, the aft core cowl 630, the core nozzle 640, and the core plug 650 may correspond to a set of nested, annular, and/or tapered sleeves. For example, the third stream nozzle 610 may be positioned radially outward with respect to and surround the forward core cowl 620. The forward core cowl 620 may be positioned radially outward with respect to and surround the aft core cowl 630. The aft core cowl 630 may be positioned radially outward with respect to and surround the core nozzle 640. The core nozzle may be positioned radially outward with respect to and surround the core plug 650. The centerline axis of each of the third stream nozzle 610, the forward core cowl 620, the aft core cowl 630, the core nozzle 640, and/or the core plug 650 may each be aligned with the centerline axis 124 of the engine 120 and canted downward toward the ground and/or laterally outward with respect to the fuselage 112. Thus, the axial direction of the third stream nozzle 610, the forward core cowl 620, the aft core cowl 630, the core nozzle 640, and/or the core plug 650 may extend along the forward-aft direction and/or the upstream-downstream direction of the engine 120 and be canted downward and/or outward by a cant angle as described below with reference to FIG. 8.

The third stream nozzle 610 may correspond to the most radially outward and most forward portion of the outlet nozzle 600 along the centerline axis 24. Thus, the third stream nozzle 610 may form the outside surface of the outlet nozzle 600 at the forward/upstream end of the forward core cowl 620 and surround and protect the forward core cowl 620. In some implementations, the third stream nozzle 610 may have a fusiform shape and/or a bulging cylindrical shape to reduce drag and/or to prevent the fan stream 156 from impinging upon any bypass and/or exhaust streams. The forward core cowl 620 may extend axially in the aft/downstream direction and taper in the aft/downstream direction to compress exhaust gases traveling toward the aft core cowl 630, the core nozzle 640, and the core plug 650. The aft end of the forward core cowl 620 may surround the forward end of the aft core cowl 630. The external nacelle 605 may be scrubbed by the fan stream 156. The fan stream 156 may correspond to the bypass flow of the engine 120. The third stream nozzle 610 may expel a third stream 810. The third stream 810 may provide a portion of the thrust generated by the engine 120. The forward core cowl 620 may expel cowl vent flow stream 820. The cowl vent flow stream 820 may correspond to a minor flow of cooling air. In other implementations, the forward core cowl 620 may be sealed to the aft core cowl 630 and the cowl vent flow stream 820 may not be generated. The forward core cowl 620 may be scrubbed by the third stream 810.

The aft core cowl 630 may include an aft core cowl segment 635. The aft core cowl segment 635 may have a surface that corresponds to the core cowl surface 320. The core nozzle 640 may include a core nozzle segment 645. The core nozzle segment 645 may have a surface that corresponds to the core nozzle surface 310. The core nozzle segment 645 may include an interior surface having a decreasing surface curvature in the axial direction toward the exhaust end of the outlet nozzle 600 and may have a decreasing cross-sectional area that is normal to the axial direction. The aft core cowl segment 635 may have an exterior surface having a decreasing surface curvature in the axial direction toward the exhaust end of the outlet nozzle 600 and may have a decreasing cross-sectional area that is normal to the axial direction. The aft core cowl 630 may be scrubbed by a shear flow stream 830. The shear flow stream 830 may include a mixture of the third stream 810, the cowl vent flow stream 820, and/or the bypass flow of the fan stream 156. The shear flow stream 830 may scrub the outer surface of the aft core cowl 630. The core nozzle 640 may expel a core exhaust stream 840.

The decreasing surface curvature of the interior surface of the core nozzle segment 645 and the decreasing surface curvature of the exterior surface of the aft core cowl segment 635 may both transition into surfaces that are parallel, or approximately parallel, with respect to each other along the axial direction toward the exhaust end of the outlet nozzle 600, such that, during operation of the turbomachine 154, the fan 122, and the outlet nozzle 600, the shear flow stream 830 scrubbing the aft core cowl 630 entrains the core exhaust stream 840 expelled through the core nozzle 640. Furthermore, the decreasing surface curvature of the interior surface of the core nozzle segment 645 and the decreasing surface curvature of the exterior surface of the aft core cowl segment 635 may both transition into surfaces that are parallel with respect to each other along the axial direction toward the exhaust end of the outlet nozzle 600, such that, during operation of the turbomachine 154, the shear flow stream 830, which may include the third stream 810 and/or the bypass flow of the fan stream 156, is parallel to the core exhaust stream 840 and/or generates an eductor effect on the core exhaust stream 840.

The core cowl angle α_{CC} 330 between the outer surface of the core nozzle segment 645 and the interior surface of the aft core cowl segment 635 may transition from a first non-zero value to a second non-zero or zero value. The first and second values may be based on the differences in size and shape between the forward ends of the core nozzle 640 and the aft core cowl 630 and the aft ends of the core nozzle 640 and the aft core cowl 630. For example, in some implementations, the core cowl angle α_{CC} 330 between the outer surface of the core nozzle segment 645 and the interior surface of the aft core cowl segment 635 may transition from about 5 degrees to about 0 degrees. In other implementations, the core cowl angle α_{CC} 330 between the outer surface of the core nozzle segment 645 and the interior surface of the aft core cowl segment 635 may transition from a value above 5 degrees to a value less than 1 degree, from a value above 5 degrees to a value less than 0.5 degrees, from a value above 5 degrees to a value less than 0.25 degrees, from about 10 degrees to about 5 degrees, from about 10 degrees to about 0 degrees, and/or any other first value in the range of 20 degrees to 5 degrees to a second value in the range of 5 degrees to 0 degrees.

The core plug 650 may be positioned coaxially and radially inward with respect to the core nozzle 640. The core plug 650 may correspond to the plug 158 and facilitate directly the flow of the core exhaust stream 840. In some implementations, the core plug 650 may include a center vent tube 655. Thus, the core plug 650 may be at least partially hollow and include a flowpath that enables a center vent exhaust stream 850 to exit via the center vent tube 655. The center vent tube 655 may be used for sump ventilation and/or oil sump pressurization and may extend past the end of the core nozzle 640 so that the center vent exhaust stream 850 contacts ambient air upon exit of the center vent tube 655. In other implementations, the core plug 650 may not include a center vent tube 655 and the core plug 650 may not extend past a plane defined by the exhaust end of the core nozzle 640. Thus, all parts of the core plug 650 may be internal to the core nozzle 640.

As shown in FIG. 8, the aft core cowl 630, the core nozzle 640, and/or the core plug 650 may be canted with respect to the centerline axis 124 and therefore with respect to the wing 114. A core nozzle centerline axis 860 of the core nozzle 640 may be canted downward (e.g., toward the ground) and/or laterally outward relative to the centerline axis 124 by a cant angle 862. In some implementations, the cant angle 862 may be about 4 degrees. In other implementations, the cant angle 862 may be higher or lower than 4 degrees.

In some implementations, the cant angle 862 may be adjustable. For example, the core nozzle 640 may include a fixed portion 864, which includes an upper fixed portion 866 and a lower fixed portion 868, and a movable portion extending from a movable end 870 aft to the outlet of the core nozzle 640. The movable portion of the core nozzle 640 may include a first portion 872 and a second portion 874. The movable portion of the core nozzle 640 may be movable from a first position to a second position. In a first position, the upper fixed portion 866 may be aligned with and/or abut the first portion 872 and the lower fixed portion 868 may be aligned with and/or abut the second portion 874. In the second position (not shown in FIG. 8), the upper fixed portion 866 may be aligned with and/or abut the second portion 874 and the lower fixed portion 868 may be aligned with and/or abut the first portion 872. The first portion 872 and the second portion 874 may be shaped to form a wedge with a movable portion angle 875. Therefore, when the first portion 872 and the second portion 874 move from the first position to the second position, the cant angle 862 may change based on the movable portion angle 875. Thus, the cant angle 862 may change from the first position to the second position. A surface of the movable end 870 may be substantially annular in shape and include a seal with the fixed portion 864, such as, for example, a stepped, flexible surface, a turkey-feather seal, etc. The seal may reduce or inhibit air leakage from the core exhaust stream 840.

The core nozzle 640 may include an actuator 876, attached to fixed portion 864 and configured to rotate the movable portion and move the first portion 872 and the second portion 874 between the first position and the second position. The actuator 876 may include a linear or rotary actuator. In other implementations, fixed portion 864 may include multiple actuators 876. The core nozzle 640 may further include a strut 878 that connects the core plug 650 to the movable portion of the core nozzle 640. While a single strut 878 is shown in FIG. 8, in practice the core nozzle 640 may include multiple struts 878. Furthermore, the core nozzle 640 may include one or more rivets 880 that connect the aft core cowl 630 to the core nozzle 640. Thus, the aft core cowl 630 and the core plug 650 may move with the movable portion of the core nozzle 640 when the actuator 876 moves the first portion 872 and the second portion 874 between the first position and the second position.

By moving the core nozzle 640 between the first position and the second position, the angle of the shear flow stream 830 (and thus the angle of the third stream 810) and the core exhaust stream 840 with respect to the centerline axis 124 may be adjusted. For example, the angle of the shear flow stream 830 and the core exhaust stream 840 may be adjusted away from takeoff components that aid in lifting the aircraft 100 during a takeoff operating mode. The takeoff components may include, for example, high lift devices, a trailing edge flap system, the wing 114, or a horizontal tail. Additionally, the direction of thrust may be adjusted between the first position and the second position. For example, the thrust may be represented as a sum of a vertical thrust vector and a horizontal thrust vector in the downstream direction. The amount of vertical thrust may vary between the first position and the second position. For example, direction between 5% to 25% of the total thrust downward in the vertical direction may enable the core exhaust stream 840 to be directed away from takeoff components of the aircraft 100 without adversely affecting the takeoff efficiency of the aircraft 100.

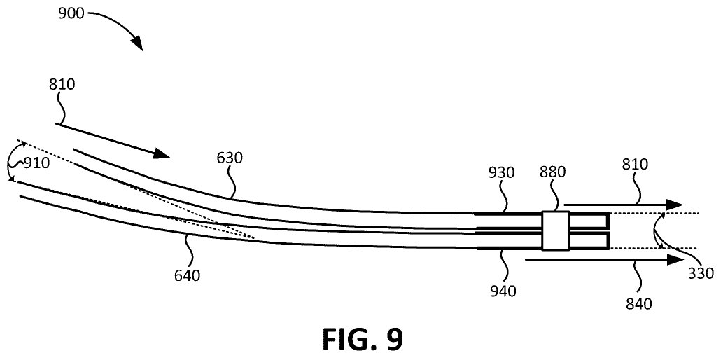

FIG. 9 is a cross-sectional diagram 900 of a connection between the aft core cowl 630 and the core nozzle 640. As shown in FIG. 9, the aft core cowl 630 and the core nozzle 640 may have a decreasing curvature in the aft/downstream direction toward the exhaust end of the core nozzle 600. The decreasing curvature, and in particular the decreasing curvature of the interior surface of the core nozzle 640 and the decreasing curvature of the exterior surface of the aft core cowl 630, may decrease from a tangent angle 910 toward the core cowl angle α_{CC} 330, in order to guide the third stream 810 into a direction of flow to entrain the core exhaust stream 840. In some implementations, the tangent angle 910 may be approximately 10 degrees. While the core cowl angle α_{CC} 330 is shown as 0 in FIG. 9, the core cowl angle α_{CC} 330 need not be 0 and may be any value below the threshold value T of the core cowl angle α_{CC} 330 that enables entrainment of the core exhaust stream 840 by the third stream 810.

The aft core cowl 630 may include an aft core cowl end section 930 and the core nozzle 640 may include a core nozzle end section 940. The aft core cowl end section 930 and the core nozzle end section 940 may be positioned at the core cowl angle α_{CC} 330 with respect to each other. The aft core cowl end section 930 and the core nozzle end section 940 may be riveted together with rivets 880. For example, rivets 880 may be spaced apart at particular intervals around the circumference of the outlet of the core nozzle 640 and may ensure that a consistent core cowl angle α_{CC} 330 is maintained around the entirety of the outlet of the core nozzle 640. In some implementations, the aft core cowl end section 930 and the core nozzle end section 940 may be reinforced with extra material. Thus, when the core cowl angle α_{CC} 330 is approximately 0, the core nozzle 640 and the aft core cowl 630 may be riveted together at surfaces that are parallel with respect to each other.

In other implementations, the aft core cowl end section 930 and the core nozzle end section 940 may be secured together using a different type of fastening mechanism. For example, the aft core cowl end section 930 and the core nozzle end section 940, and/or other components of the outlet nozzle 600, may be fusion welded together using machined rings of the same material, such as Titanium, an Inconel nickel-chromium based superalloy, and/or another type of material that can be fusion welded.

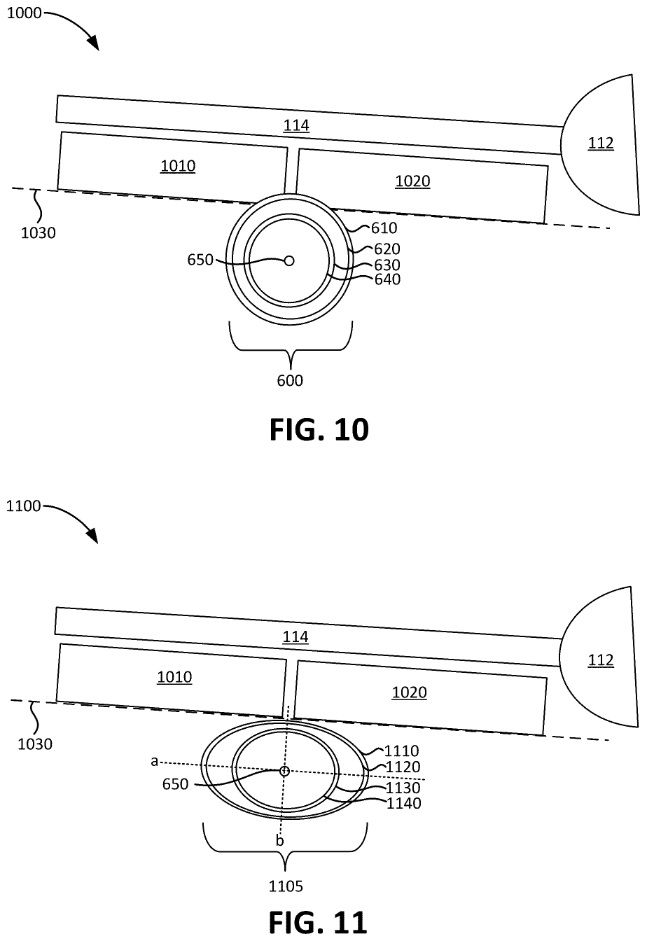

FIG. 10 is a rear view 1000 of the outlet nozzle 600 mounted on the aircraft 100. As shown in FIG. 10, the outlet nozzle 600 may be mounted on the wing 114. The outlet nozzle 600 may be mounted on the wing 114 through the pylon 118 (not shown in FIG. 10). The outlet nozzle 600 may have a substantially circular cross-section when viewed in the upstream direction from the rear. For example, the third stream nozzle 610, the forward core cowl 620, the aft core cowl 630, and/or the core nozzle 640 may each have a substantially cross-sectional area. However, a circular cross-section may interfere with the wing flap system. The wing 114 may include a first wing flap 1010 and a second wing flap 1020. The first wing flap 1010 and the second wing flap 1020 have a trailing edge 1030. When the first wing flap 1010 and the second wing flap 1020 are deployed, the trailing edge 1030 may reach below the top of the outlet nozzle 600 and the exhaust gases from the outlet nozzle 600 may impinge on the first wing flap 1010 and the second wing flap 1020.

FIG. 11 is a rear view 1100 of an elliptical outlet nozzle 1105. As shown in FIG. 11, the elliptical outlet nozzle 1105 may have an elliptical cross-section in a plane normal to the axial direction, the axial direction being the centerline axis 124 of the engine 120. The elliptical outlet nozzle 1105 may include an elliptical third stream nozzle 1110, an elliptical forward core cowl 1120, an elliptical aft core cowl 1130, and an elliptical core nozzle 1140. The elliptical third stream nozzle 1110, the elliptical forward core cowl 1120, the elliptical aft core cowl 1130, and/or the elliptical core nozzle 1140 may each have an elliptical cross-section in a plane normal to the axial direction, the axial direction being the centerline axis 124 of the engine 120.

The nozzle exit, as viewed looking upstream into the elliptical outlet nozzle 1105, can be described as an ellipse with a and b semi-major axis lengths, where a is oriented approximately parallel to a ground plane or a wingspan of the aircraft, and where b is vertical and normal to a. As a increases relative to b, the ellipse becomes flatter, and when a and b are equal, the nozzle exit is perfectly circular. The elliptical outlet nozzle 1105, as viewed upstream into nozzle, from nozzle exit, may avoids flap impingement, because when the first wing flap 1010 and the second wing flap 1020 are deployed, the trailing edge 1030 does not reach below the top of the elliptical outlet nozzle 1105 and the exhaust gases from the elliptical outlet nozzle 1105 do not impinge on the first wing flap 1010 and the second wing flap 1020. Thus, the elliptical cross section includes a semimajor axis a that is parallel to the trailing edge 1030 of the wing flaps 1010 and 1020 of the aircraft 100 when the wing flaps 1010 and 1020 are deployed, and the core exhaust stream 840 and/or the third stream 810 substantially avoid flap impingement when the wing flaps are deployed. Furthermore, the elliptical outlet nozzle 1105 may maintain the same amount of thrust as a circular nozzle with the same cross-section. In contrast, if a circular nozzle is reduced in cross-section to avoid flap impingement, the smaller circular nozzle may generate less thrust.

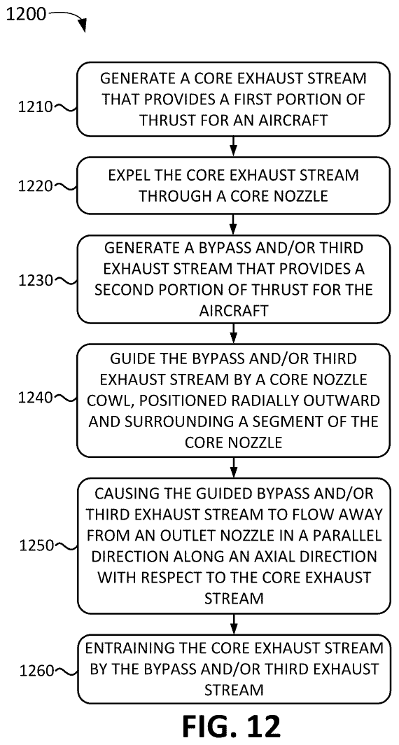

FIG. 12 is a flowchart of an exemplary process 1200 performed by an outlet nozzle. In some implementations, the process 1200 may be performed by the outlet nozzle 600. In other implementations, some or all of the process 1200 may be performed by another device or groups of devices separate from the outlet nozzle 600.

The process 1200 may include generating a core exhaust stream that provides a first portion of thrust for an aircraft (block 1210) and expelling the core exhaust stream through a core nozzle (block 1220). For example, the unducted thrust producing system of the engine 120 may generate expanding gases, using the combustor 168, that enter the core nozzle 640 of the outlet nozzle 600, become compressed into the core exhaust stream 840, and exit the core nozzle 640.

The process 1200 may further include generating a bypass and/or third exhaust stream that provides a second portion of the thrust for the aircraft (block 1230) and guiding the bypass exhaust stream by an aft core cowl that is positioned radially outward and surrounding a segment of the core nozzle (block 1240). For example, the unducted thrust producing system of the engine 120 may generate the fan stream 156 by the fan 122 and the generated fan stream 156 may scrub the third stream nozzle 610 of the outlet nozzle 600. Furthermore, the unducted thrust producing system of the engine 120 may generate a flow of air, through the fan 122, that enters the bypass flowpath 160, becomes compressed into the third stream 810, and exits the third stream nozzle 610 as the third stream 810. The third stream 810, and/or the bypass stream of the fan stream 156, may scrub the external surfaces of the forward core cowl 620 and the aft core cowl 630 and be guided by the external surfaces of the forward core cowl 620 and the aft core cowl 630 to follow the shape of the external surfaces of the forward core cowl 620 and the aft core cowl 630.

The process 1200 may further include causing the guided bypass and/or third exhaust stream to exit an outlet nozzle in a parallel direction along an axial direction with respect to the core exhaust stream (block 1250) and entraining the core exhaust stream by the bypass exhaust stream (block 1260). For example, the decreasing interior surface curvature of the core nozzle segment 645 and the decreasing exterior surface curvature of the aft core cowl segment 635 may guide the shear flow stream 830, which includes the third stream 810 and/or a portion of the fan stream 156, into a substantially parallel direction of flow with respect to the core exhaust stream 840 as the shear flow stream 830 and the core exhaust stream 840 flow away from the outlet nozzle 600, resulting in the third stream 810 and/or the bypass flow of the fan stream 156 entraining the core exhaust stream 840 and/or causing the third stream 810 and/or the bypass flow of the fan stream 156 to generate an eductor effect on the core exhaust stream 840.

The implementations described herein may further include various modifications. For example, the outlet nozzle 600 and/or the elliptical outlet nozzle 1105 include a non-axisymmetric nozzle. A non-axisymmetric nozzle may be desirable, even in stowed mode, to manage any LPT distortion in deployed mode. As explained above, the outlet nozzle 600 and/or the elliptical outlet nozzle 1105 may be integrated with a center vent tube 655. Furthermore, the outlet nozzle 600 and/or the elliptical outlet nozzle 1105 may be integrated with a heatshield and/or aft pylon fairing and/or be deployed on an aft fuselage mounted aircraft. In an aft fuselage mounted aircraft, more emphasis may be placed on the outlet nozzle 600 forcing the exhaust air flow laterally and therefore the outlet nozzle 600 may be canted more laterally than for wing-mounted aircraft. Moreover, deploying use of the outlet nozzle 600 and/or the elliptical outlet nozzle 1105 during landing may alleviate reverse thrust requirements as forward thrust may be spoiled when the core exhaust is vectored.

Further aspects of the disclosure are provided by the subject matter of the following clauses:

An unducted thrust producing system for an aircraft, the unducted thrust producing system comprising: a turbomachine; a fan rotatably driven by the turbomachine; and an outlet nozzle, canted downward and/or laterally outward with respect to a centerline axis of the turbomachine, wherein during operation of the turbomachine and fan, an exhaust stream is expelled from the outlet nozzle, the outlet nozzle comprising: a core nozzle comprising a core nozzle segment with an interior surface having a decreasing surface curvature in an axial direction toward an exhaust end of the outlet nozzle and with a decreasing cross-sectional area that is normal to the axial direction; and an aft core cowl, positioned radially outward with respect to and surrounding the core nozzle segment, wherein the aft core cowl comprises an aft core cowl segment with an exterior surface which may have a decreasing surface curvature in the axial direction toward the exhaust end of the outlet nozzle and with a decreasing cross-sectional area that is normal to the axial direction, and wherein the decreasing surface curvature of the core nozzle segment and the decreasing surface curvature of the aft core cowl segment, if present, both transition into surfaces that are parallel with respect to each other along the axial direction toward the exhaust end of the outlet nozzle, such that during operation of the unducted thrust producing system, a bypass or third exhaust stream scrubbing the aft core cowl entrains a core exhaust stream expelled through the core nozzle.

The unducted thrust producing system of any preceding clause, wherein the outlet nozzle includes a fixed portion and a movable portion, wherein the movable portion is movable from a first position to a second position, and wherein a cant angle of the movable portion with respect to a centerline axis of the turbomachine changes between the first position and the second position.

The unducted thrust producing system of any preceding clause, wherein the core nozzle and the aft core cowl are riveted together at the surfaces that are parallel with respect to each other.

The unducted thrust producing system of any preceding clause, wherein an aft core cowl angle between the aft core cowl and the core nozzle transitions from five degrees or more to one degree or less in the axial direction toward the exhaust end of the outlet nozzle.

The unducted thrust producing system of any preceding clause, wherein the bypass or third exhaust stream is parallel to the core exhaust stream.

The unducted thrust producing system of any preceding clause, wherein the bypass or third exhaust stream generates an eductor effect on the core exhaust stream.

The unducted thrust producing system of any preceding clause, wherein the outlet nozzle further includes a core plug, positioned coaxially and radially inward with respect to the core nozzle, and wherein the core plug includes a center vent tube.

The unducted thrust producing system of any preceding clause, wherein the outlet nozzle includes an elliptical cross section in a plane normal to the axial direction.

The unducted thrust producing system of any preceding clause, wherein the elliptical cross section includes a semi-major axis that is parallel to a trailing edge of wing flaps of the aircraft when the wing flaps are deployed, and wherein the exhaust stream substantially avoids flap impingement when the wing flaps are deployed.

The unducted thrust producing system of any preceding clause, wherein the fan is unducted.

An aircraft comprising: a fuselage; a wing extending outward from the fuselage; an engine mounted on the wing, and the unducted thrust producing system of any preceding clause mounted to the wing.

The aircraft of any preceding clause, wherein the outlet nozzle includes a fixed portion and a movable portion, wherein the movable portion is movable from a first position to a second position, and wherein a cant angle of the movable portion with respect to a centerline axis of the turbomachine changes between the first position and the second position.

The aircraft of any preceding clause, wherein the core nozzle and the aft core cowl are riveted together at the surfaces that are parallel with respect to each other.

The aircraft of any preceding clause, wherein an aft core cowl angle between the aft core cowl and the core nozzle transitions from five degrees or more to one degree or less in the axial direction toward the exhaust end of the outlet nozzle.

The aircraft of any preceding clause, wherein the bypass or third exhaust stream is parallel to the core exhaust stream.

The aircraft of any preceding clause, wherein the outlet nozzle includes an elliptical cross section in a plane normal to the axial direction.

The aircraft of any preceding clause, wherein the elliptical cross section includes a semimajor axis that is parallel to a trailing edge of wing flaps of the aircraft when the wing flaps are deployed, and wherein the exhaust stream substantially avoids flap impingement when the wing flaps are deployed.

A method of generating thrust, performed by the unducted thrust producing system of any preceding clause, the method comprising: generating, by the unducted thrust producing system of any preceding clause, a core exhaust stream providing a first portion of a thrust for the aircraft; expelling, by the unducted thrust producing system, the core exhaust stream via a core nozzle; generating, by the unducted thrust producing system, a bypass or third exhaust stream, wherein the bypass or third exhaust stream provides a second portion of the thrust for the aircraft; guiding, by the unducted thrust producing system, the bypass or third exhaust stream by an aft core cowl, positioned radially outward with respect to and surrounding the core nozzle, wherein the aft core cowl comprises an end section that has a substantially parallel surface in an axial direction with respect to a surface of the core nozzle; and causing the guided bypass or third exhaust stream to flow away from the unducted thrust producing system in a parallel direction along the axial direction with respect to the core exhaust stream.

The method of the preceding clause, wherein the method is performed by an aircraft that includes the unducted thrust producing system of any preceding clause.

The method of any preceding method clause, wherein causing the guided bypass or third exhaust stream to flow away from the unducted thrust producing system in the parallel direction along the axial direction with respect to the core exhaust stream includes: generating an eductor effect on the core exhaust stream by the bypass or third exhaust stream.

In the preceding specification, various preferred embodiments have been described with reference to the accompanying drawings. It will, however, be evident that various modifications and changes may be made hereto, and additional embodiments may be implemented, without departing from the broader scope of the invention as set forth in the claims that follow. The specification and drawings are accordingly to be regarded in an illustrative rather than restrictive sense.

What is claimed is:

1. An unducted thrust producing system for an aircraft, the unducted thrust producing system comprising:
a turbomachine;
a fan rotatably driven by the turbomachine; and
an outlet nozzle, canted downward and/or laterally outward with respect to a centerline axis of the turbomachine, wherein during operation of the turbomachine and fan, an exhaust stream is expelled from the outlet nozzle, the outlet nozzle comprising:
a core nozzle comprising a core nozzle segment with a decreasing cross-sectional area that is normal to an axial direction toward an exhaust end of the outlet nozzle; and
an aft core cowl, positioned radially outward with respect to and surrounding the core nozzle segment, wherein the aft core cowl comprises an aft core cowl segment with a decreasing cross-sectional area that is normal to the axial direction, and wherein a surface of the core nozzle segment and a surface of the aft core cowl segment both transition into surfaces that are parallel with respect to each other along the axial direction toward the exhaust end of the outlet nozzle, such that during operation of the unducted thrust producing system, a bypass or third exhaust stream scrubbing the aft core cowl entrains a core exhaust stream expelled through the core nozzle.

2. The unducted thrust producing system of claim 1, wherein the outlet nozzle includes a fixed portion and a movable portion, wherein the movable portion is movable from a first position to a second position, and wherein a cant angle of the movable portion with respect to a centerline axis of the turbomachine changes between the first position and the second position.

3. The unducted thrust producing system of claim 1, wherein the core nozzle and the aft core cowl are riveted together at the surfaces that are parallel with respect to each other.

4. The unducted thrust producing system of claim 1, wherein an aft core cowl angle between the aft core cowl and the core nozzle transitions from five degrees or more to one degree or less in the axial direction toward the exhaust end of the outlet nozzle.

5. The unducted thrust producing system of claim 1, wherein the bypass or third exhaust stream is parallel to the core exhaust stream.

6. The unducted thrust producing system of claim 5, wherein the bypass or third exhaust stream generates an eductor effect on the core exhaust stream.

7. The unducted thrust producing system of claim 1, wherein the outlet nozzle further includes a core plug, positioned coaxially and radially inward with respect to the core nozzle, and wherein the core plug includes a center vent tube.

8. The unducted thrust producing system of claim 1, wherein the outlet nozzle includes an elliptical cross section in a plane normal to the axial direction.

9. The unducted thrust producing system of claim 8, wherein the elliptical cross section includes a semi-major axis that is parallel to a trailing edge of wing flaps of the aircraft when the wing flaps are deployed, and wherein the exhaust stream substantially avoids flap impingement when the wing flaps are deployed.

10. The unducted thrust producing system of claim 1, wherein the fan is unducted.

11. An aircraft comprising:
a fuselage;
a wing extending outward from the fuselage;
an engine mounted on the wing, and
the unducted thrust producing system of claim 1 mounted to the wing.

12. The aircraft of claim 11, wherein the outlet nozzle includes a fixed portion and a movable portion, wherein the movable portion is movable from a first position to a second position, and wherein a cant angle of the movable portion with respect to a centerline axis of the turbomachine changes between the first position and the second position.

13. The aircraft of claim 11, wherein the core nozzle and the aft core cowl are riveted together at the surfaces that are parallel with respect to each other.

14. The aircraft of claim 11, wherein an aft core cowl angle between the aft core cowl and the core nozzle transitions from five degrees or more to one degree or less in the axial direction toward the exhaust end of the outlet nozzle.

15. The aircraft of claim 11, wherein the bypass or third exhaust stream is parallel to the core exhaust stream.

16. The aircraft of claim 11, wherein the outlet nozzle includes an elliptical cross section in a plane normal to the axial direction.

17. The aircraft of claim 16, wherein the elliptical cross section includes a semimajor axis that is parallel to a trailing edge of wing flaps of the aircraft when the wing flaps are deployed, and wherein the exhaust stream substantially avoids flap impingement when the wing flaps are deployed.

18. A method of generating thrust, performed by the unducted thrust producing system of claim 1, the method comprising:
generating, by the unducted thrust producing system, a core exhaust stream providing a first portion of a thrust for the aircraft;
expelling, by the unducted thrust producing system, the core exhaust stream via a core nozzle;
generating, by the unducted thrust producing system, a bypass or third exhaust stream, wherein the bypass or third exhaust stream provides a second portion of the thrust for the aircraft;
guiding, by the unducted thrust producing system, the bypass or third exhaust stream by an aft core cowl, positioned radially outward with respect to and surrounding the core nozzle, wherein the aft core cowl comprises an end section that has a substantially parallel surface in an axial direction with respect to a surface of the core nozzle; and
causing the guided bypass or third exhaust stream to flow away from the unducted thrust producing system in a parallel direction along the axial direction with respect to the core exhaust stream.

19. The method of claim 18, wherein the method is performed by an aircraft that includes the unducted thrust producing system.

20. The method of claim 18, wherein causing the guided bypass or third exhaust stream to flow away from the unducted thrust producing system in the parallel direction along the axial direction with respect to the core exhaust stream includes:
generating an eductor effect on the core exhaust stream by the bypass or third exhaust stream.
